(19) United States
(12) Patent Application Publication
(10) Pub. No.: US 2004/0001733 A1
(43) Pub. Date: Jan. 1, 2004

(54) Print medium transport path for a printing device

(76) Inventors: Dean Richtsmeier, Boise, ID (US); Harold M. Miller, Nampa, ID (US)

Correspondence Address: HEWLETT-PACKARD COMPANY, Intellectual Property Administration, P.O. Box 272400, Fort Collins, CO, 80527-2400, US

(21) Appl. No.: 10/186,819

(22) Filed: Jun. 28, 2002

(51) Int. Cl. G03G 15/00

(52) U.S. Cl. 399/397

(57) ABSTRACT

A print medium transport path for a printing device transports a sheet of print medium that is charged to facilitate receipt of charged toner forming an image to be printed. The transport path includes a transfer roller for transferring said image to said print medium, a pressing roller for pressing said print medium after receipt of said image and a number of ribs running between said transfer roller and said pressing roller. The ribs are substantially parallel and spaced from each other to define the transport path.

### FIELD OF THE INVENTION

The present invention relates generally to the field of printing devices. More particularly, the present invention relates to a transport path for print media within a printing device.

### BACKGROUND OF THE INVENTION

Laser printers, copiers, and other similar printing devices mainly include: a photosensitive drum, a developing roller, and a transfer roller or corona wires. In general, in such printing devices, an image is created on the photosensitive drum and then transferred to a sheet of print media. As used herein, and in the appended claims, the terms “printing device” or “printer” will be understood to refer to all such devices that output a hardcopy document based on the transfer of an image from a drum to a sheet of print media.

In a typical printing device, a charging device uniformly applies an electrical charge to the outer peripheral surface of the photosensitive drum. A laser-generating unit modulates a laser beam based on data defining the image to be printed. The modulated laser beam is then scanned across the outer peripheral surface of the photosensitive drum. As a result, a corresponding electrostatic latent image is formed on the surface of the photosensitive drum in the charge pattern on the drum.

The developing roller conveys, on its surface, toner that is electrically charged to the same polarity as that of the charge on the photosensitive drum. Consequently, the toner will be repelled by the photosensitive drum, except where the latent image has been written into the charges on the drum. The electrostatic latent image on the photosensitive drum is thus developed into a visible toner image by the toner supplied from the developer roller.

The developed visible image is then transferred from the photosensitive drum onto a sheet of paper, or other print medium, that is passing between the photosensitive drum and the transfer roller or corona wires. The transfer roller or corona wires transfer a static charge to each sheet of paper. This charge in turn attracts the toner from the drum to the paper causing the image to be transferred to the paper under pressure from the transfer roller.

Once the visible image is on the sheet of paper, the paper passes through a designated paper path delimited by solid plastic on its way to a fuser roller. Once the paper reaches the fuser roller, the roller heats the page causing the toner to partially melt and stick to the paper forming a permanent bond.

During this process, the paper, or other print medium, is charged to at least 1,500 to 2,000V by the corona wires or the transfer roller of the printer in order for the visible image to be transferred from the photosensitive drum to the paper efficiently and to effectively hold the toner onto the paper until it is fused. If this charge is permitted to remain on the paper, a large resulting electrostatic force is developed between the plastic making up the paper path and the charged paper. The resulting electrostatic force tends to displace the paper away from the intended path thereby increasing the likelihood of a jam or a displacement of the toner from the print medium.

FIG. 2 illustrates a conventional paper transport path in which this problem typically occurs. As shown in FIG. 2, a paper transport path (24a) runs between a transfer roller (22) and a pressing roller (26) of a fuser. The transport path (24a) is essentially a solid sheet of plastic along which the paper or other print medium slides between the two rollers (22 and 26). The electrostatic charge on the paper tends to displace the paper away from the solid sheet of plastic that is the transport path (24a). This may cause toner to be dislodged from the print medium, thereby degrading the quality of the printed image and dirtying the interior of the printing device. The displacement of the paper also increases the likelihood that the paper will misfeed and jam the printing device.

One solution to the problem of the resulting electrostatic force is to use a discharge comb in connection with the transfer roller to reduce the charge and thereby reduce the resulting electrostatic force. The use of a discharge comb is not new in the art. U.S. Pat. No. 4,392,711 (which is incorporated herein by reference in its entirety) demonstrates that a discharge comb may be used to eliminate residual charges, which may be left on the rear side of a previously charged print medium.

However, while the implementation of adding a discharge comb reduces the electrostatic force between the paper and the plastic paper path, it also has disadvantages. Use of a discharge comb increases the overall cost of the printer design. Increased costs to secure and assemble the discharge comb are also added to the overall cost of the printer design. Furthermore, the addition of the discharge comb increases the possibility of paper jams given that envelopes and other print medium may contact the discharge comb obstructing the paper path.

Another prior solution to the resulting electrostatic force between the charged print medium and the plastic paper path is to replace at least some of the plastic of the paper path with metal. Since metal is less likely to accumulate a static charge, there is a reduced chance of static electricity displacing the print medium moving through the transport path. However, there are increased manufacturing costs associated with replacing the plastic of the paper path with metal.

### SUMMARY OF THE INVENTION

The present invention provides, among other things, a print medium transport path for a printing device in which a sheet of print medium is charged to facilitate receipt of charged toner forming an image to be printed. A transport path according to the present invention preferably includes a transfer roller for transferring the image to the print medium, a pressing roller for pressing the print medium after receipt of the image, and a plurality of ribs running between the transfer roller and the pressing roller. The ribs are substantially parallel and spaced from each other to define the transport path.

### BRIEF DESCRIPTION OF THE DRAWINGS

The accompanying drawings illustrate embodiments of the present invention and are a part of the specification. Together with the following description, the drawings demonstrate and explain the principles of the present invention. The illustrated embodiments are examples of the present invention and do not limit the scope of the invention.

FIG. 1a illustrates an embodiment of a printing device according to principles present invention.

FIG. 1b illustrates another embodiment of a printing device according to principles present invention.

FIG. 2 shows a perspective view of the prior art laser printer design.

FIG. 3 shows a perspective view of an embodiment of a printer design that does not utilize a discharge comb according to principles of the present invention.

FIG. 4 shows a cross sectional view of another possible embodiment of the present invention that utilizes a firewall for circuitry protection.

Throughout the drawings, identical reference numbers designate similar, though not necessarily identical, elements.

### DETAILED DESCRIPTION OF EMBODIMENTS OF THE INVENTION

In one of many possible embodiment, the present invention provides a print medium transport path for a printing device in which a sheet of print medium is charged to facilitate receipt of charged toner forming an image to be printed. The transport path includes a transfer roller for transferring the image to the print medium, a pressing roller for pressing the print medium after receipt of the image, and a plastic guide member for guiding print media between the transfer roller and the pressing roller. The transport path does not include a discharge comb.

The present invention also provides a printing device that includes a drum on which an image to be printed is formed, a developer cylinder for developing the image on the drum with toner, a charging device for electrically charging a sheet of print medium, a transfer roller for transferring the image from the drum to the print medium, a pressing roller for pressing the print medium after receipt of the image, and a transport path comprising a plurality of ribs running between the transfer roller and the pressing roller. The ribs are substantially parallel and spaced from each other to define the transport path.

The present invention also provides a print medium transport path for a printing device in which a sheet of print medium is charged to facilitate receipt of charged toner forming an image to be printed. The transport path includes transfer means for transferring the image to the print medium, pressing means for pressing the print medium after receipt of the image, and transport means running between the transfer means and the pressing means over which the print medium is transported, the transport means presenting a minimal surface area to the print medium such that any accumulated electrostatic charges are insufficient to deflect the print medium or dislodge toner from the print medium.

The present invention also provides a method of transporting a sheet of print medium in a printing device in which the sheet of print medium is charged to facilitate receipt of charged toner forming an image to be printed by sliding the sheet of print medium over a transport path which presents a minimal surface area to the print medium such that any accumulated electrostatic charges are insufficient to deflect the print medium or dislodge toner from the print medium.

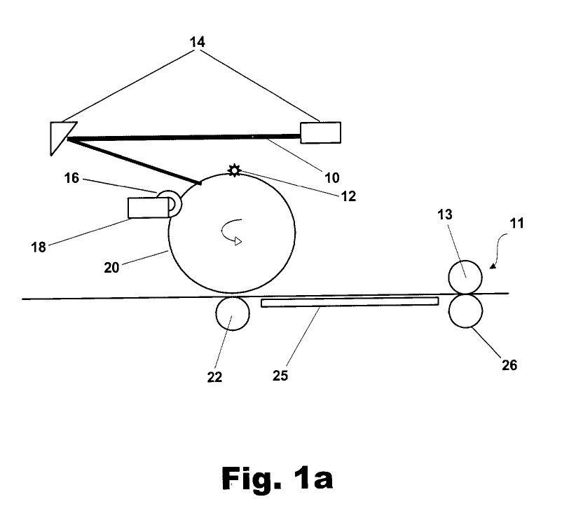

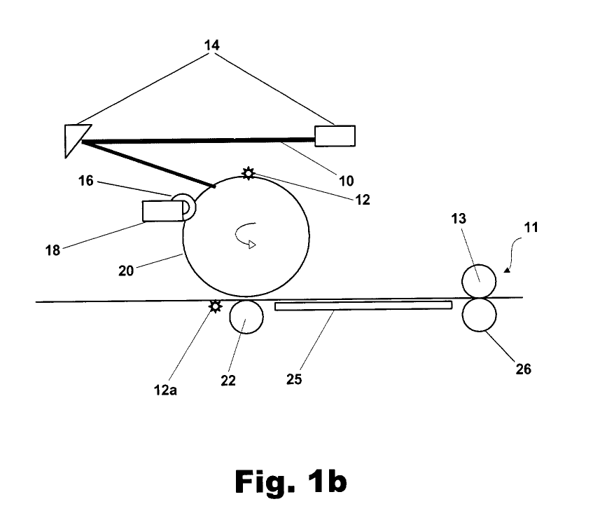

FIG. 1 a illustrates an embodiment of a printing device according to principles of the present invention. As shown in FIG. 1a, such a printing device preferably includes a corona wire (12), a laser-scanning unit (14), a developer cylinder (16), toner supply (18), a photosensitive drum (20), a transfer roller cylinder (22), a transport path (24) for print media, and a fuser (11).

When printing an image, the photosensitive drum (20) is rotated in the direction indicated by the arrow in the figure (i.e. counterclockwise). First, a charging roller or corona wire (12) uniformly charges the surface of the photosensitive drum (20). This charge is dissipated from the surface of the drum when exposed to light. Then, a laser beam (10) from a laser-scanning unit (14) selectively irradiates the surface of the photosensitive drum (20) to form an electrostatic latent image in the charges on the surface of the photosensitive drum (20).

The laser beam (10) is modulated by a laser driver of the laser-scanning unit (14) in accordance with image data that is provided to the printing device to be printed. Consequently, as the laser is scanned across the surface of the drum (20) and modulated according to the image data, the image is written in latent form into the charges on the surface of the photosensitive drum (20).

A developing device is provided with the photosensitive drum (20) and includes a developer cylinder (16) and a toner supply 18. A developing bias voltage is applied to the developer cylinder (16) from a power supply (not shown). This bias voltage charges the toner that is carried on the developer cylinder (16). The charge imparted to the toner is of the same polarity as the charge applied on the surface of the photosensitive drum (20) by the charging roller or corona wire (12). Consequently, the charged toner adheres to the electrostatic latent image formed on the surface of the photosensitive drum (20) from which the like charge has been dissipated and is repelled by other portions of the drum (20) where a like charge remains. In this way, the image is formed on the photosensitive drum (20) with toner.

With the rotation of the photosensitive drum (20), charged toner is adhered to the entire latent image on the surface of the photosensitive drum (20) by the developer cylinder (16). This, thus, fully develops the latent image on the photosensitive drum (20). Further, with the rotation of the photosensitive drum (20), sheets of print media from a supply of print media (not shown) are sequentially delivered sheet by sheet to impinge upon and stop at a pair of resist rollers (not shown). The paired resist rollers are rotated at a timing so adjusted to make a leading edge of a sheet of print medium register with the image on the photosensitive drum (20). The print medium is guided by a part of the outer surface of a cartridge and delivered to a transfer nip between the photosensitive drum (20) and a transfer roller (22).

As the print medium passes between the photosensitive drum (20) and the transfer roller (22), the print medium is charged to at least 2000V to efficiently transfer the toner of the developed image to the print medium (e.g., paper) and to hold the toner onto the print medium until it is fused. A toner image on the photosensitive drum (20) is then transferred to the print medium by the transfer roller (22).

After receiving the image transferred from the drum, the sheet of print medium is conveyed through a transport path (24) to a fuser (11). The fuser (11) includes a fixing nip disposed between a fixing roller (13) and a pressing roller (26). Once at the fuser (11), heat and pressure are applied to the print medium to fix the toner and, thus, the transferred image, on the print medium. Thereafter, the print medium is discharged from the printing device.

In FIG. 1a, the transfer roller (22) charges the print medium (25) as well as facilitating the transfer of the developed toner image from the drum (20) to the print medium (25). In FIG. 1b, an alternative embodiment is illustrated. As shown in FIG. 1b, in some printing devices, a second corona wire (12a) is disposed in the transport path of the print medium (25) to charge the print medium (25) for receipt of the toner image on the drum (20). In such a case, the transfer roller (22) would not need to charge the print medium (25), but merely facilitates the transfer of the toner image to the print medium (25).

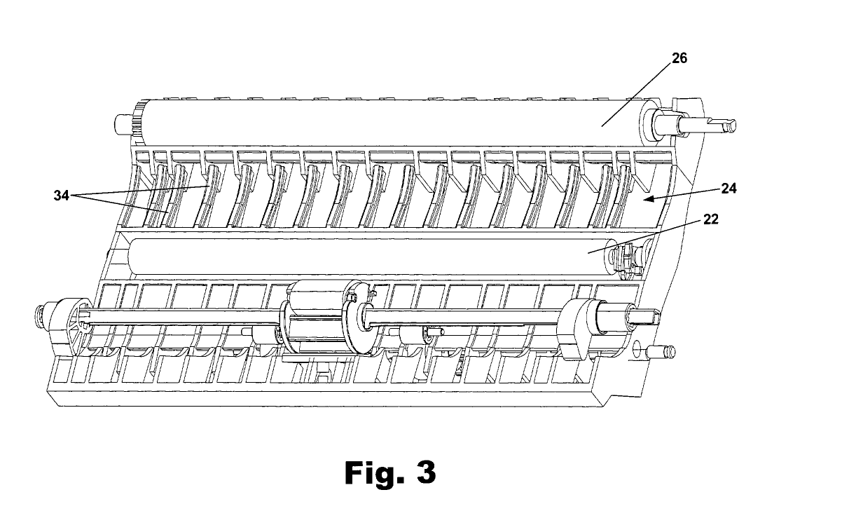

FIG. 3 shows a perspective view of one embodiment of a print media transport path in a printing device according to the present invention. FIG. 3 includes the transfer roller (22), the transport path for print media (25) with guiding support ribs (34), and the pressing roller (26) of a fuser.

As the print medium exits the transfer roller (22), it has just been charged to over 2000V in order to efficiently transfer toner to the print medium from the drum and to hold the toner on the print medium until it is fused. This charge creates a large electrostatic force between the plastic of the transport path (24) and the charged print medium causing toner displacement and print medium jams.

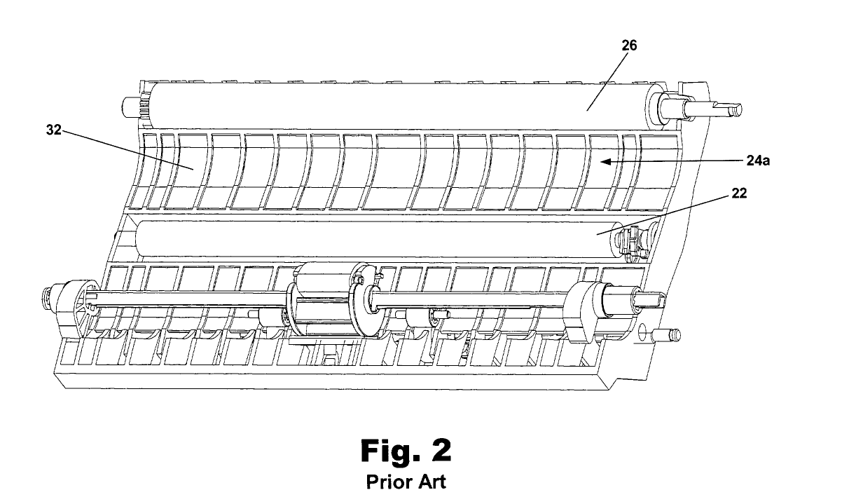

The present design eliminates the problem of electrostatic attraction between the print medium and the plastic of the paper path (24) by reducing the amount of exposed plastic in the paper path (24) thereby reducing the electrostatic forces that tend to displace the print medium as it is fed through the printing device. Under principles of the present invention, the transport path (24) is made of guiding support ribs (34) rather than a solid plastic paper path (24a), such as that illustrated in FIG. 2. The guiding support ribs (34) are spaced along the transport path (24) to present a minimal surface area of plastic exposed to the charged print medium moving along the transport path (24). The reduction in exposed surface area is sufficient to decrease the electrostatic forces that typically occur and prevent the displacement of toner and the likelihood of that the print medium will jam. This reduction of electrostatic charge eliminates the need for a discharge comb, reduces the cost of manufacture, and improves the printer's reliability.

An additional advantage of the embodiment illustrated in FIG. 3 is the ability of air for flow freely between the support ribs (34). This increases the airflow to the fuser to minimize heat build up in the printer.

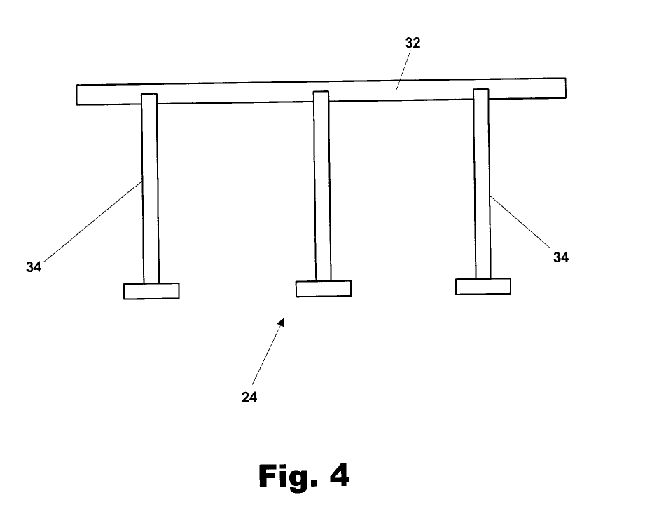

An alternative embodiment of the claimed invention can be seen in FIG. 4. FIG. 4 depicts a cross-sectional view of an alternative embodiment of the transport path (24) in which a recessed plastic piece (32) is provided between the guiding support ribs (34). This recessed piece (32) allows the transport path (24) to act as a fire enclosure.

In a number of printer applications the plastic of the paper path (24) also acts as a fire enclosure for an electronic circuit board (not shown). This prevents any fire that may arise from the electronics on the circuit board from spreading. It is particularly important to prevent any such fire from reaching the print media transport path where print media, which is typically very combustible, may be traveling.

An alternative embodiment of the present invention can provide a protective fire enclosure for an electronic circuit board in the following manner. The open spaced between the guiding support ribs (34) in the transport path (24) are covered by a recessed plastic piece (32). The recessed plastic piece (32) may then serve as a fire enclosure. The recessed plastic piece (32) is also located a sufficient distance from the charged print medium moving in the transport path (24) so as not to effect the toner adhesion or the path of the print medium due to electrostatic interaction.

The distance between the recessed plastic piece (32) and the charged print medium moving in the transport path (24) can be increased, if desired, by increasing the thickness of the guiding support ribs (34). In this way, the possibility of an electrostatic interaction between the recessed plastic piece (32) and the charged print medium can be adjusted as needed by a particular application.

In the embodiment of FIG. 4, the recessed member (32) is shown as a single sheet that spans the line or ribs (34). This sheet (32) can be integrally formed with and supporting the ribs (34). Alternatively, the recessed member (32) may be a single, but separate piece that is shaped to accommodate the ribs (34) and cover the openings between adjacent ribs so as to serve as a fire enclosure.

It will be appreciated by those of skill in the art, that the recessed member could alternatively be composed of a number of individual members, each of which is disposed between two adjacent ribs (34). With a member covering the opening between each set of adjacent ribs (34), a fire enclosure is again formed.

In conclusion, the present invention, it its various embodiment, reduces the electrostatic interaction that has typically taken place between charged print media and the transport path within a printing device. By reducing this electrostatic interaction, the print medium is less likely to loose toner or misfeed in the transport path. With the reduced likelihood of toner displacement or paper jams due to electrostatic attraction there is no longer a need to employ a discharge comb. The elimination of the discharge comb will simultaneously reduce the overall production cost of the design and increase the reliability of the resulting design.

What is claimed is:

1. A print medium transport path for a printing device in which a sheet of print medium is charged to facilitate receipt of charged toner forming an image to be printed, said transport path comprising:
a transfer roller for transferring said image to said print medium;
a pressing roller for pressing said print medium after receipt of said image; and
a plurality of ribs running between said transfer roller and said pressing roller;
wherein said ribs are substantially parallel and spaced from each other to define said transport path.

2. The transport path of claim 1, wherein said ribs are made of plastic.

3. The transport path of claim 1, further comprising a recessed plastic member spanning said plurality of ribs to cover openings between said ribs and serve as a fire enclosure.

4. The transport path of claim 1, further comprising a plurality of recessed members each of which covers an opening between adjacent said ribs, said recessed members serving as a fire enclosure.

5. The transport path of claim 3, wherein said recessed plastic member is integrally formed with said plurality of ribs.

6. The transport path of claim 1, wherein said transport path does not include a discharge comb.

7. The transport path of claim 1, further comprising openings between said ribs, said openings allowing an airflow that reduces heat accumulation at a fuser inside said printing device.

8. A print medium transport path for a printing device in which a sheet of print medium is charged to facilitate receipt of charged toner forming an image to be printed, said transport path comprising:
a transfer roller for transferring said image to said print medium;
a pressing roller for pressing said print medium after receipt of said image; and
a plastic guide member for guiding print media between said transfer roller and said pressing roller;
wherein said transport path does not include a discharge comb.

9. A printing device comprising:
a drum on which an image to be printed is formed;
a developer cylinder for developing said image on said drum with toner;
a charging device for electrically charging a sheet of print medium;
a transfer roller for transferring said image from said drum to said print medium;
a pressing roller for pressing said print medium after receipt of said image; and
a transport path comprising a plurality of ribs running between said transfer roller and said pressing roller;
wherein said ribs are substantially parallel and spaced from each other to define said transport path.

10. The printing device of claim 9, wherein said ribs are made of plastic.

11. The printing device of claim 9, further comprising a recessed plastic member spanning said plurality of ribs to cover openings between said ribs and serve as a fire enclosure.

12. The printing device of claim 11, wherein said recessed plastic member is integrally formed with said plurality of ribs.

13. The printing device of claim 9, further comprising a plurality of recessed members each of which covers an opening between adjacent said ribs, said recessed members serving as a fire enclosure.

14. The printing device of claim 9, wherein said transport path does not include a discharge comb.

15. The printing device of claim 9, further comprising a fuser which comprises said pressing roller.

16. The printing device of claim 9, further comprising a charging device for charging for charging said drum.

17. The printing device of claim 16, further comprising a modulated laser system for writing said image to said charged drum.

18. A print medium transport path for a printing device in which a sheet of print medium is charged to facilitate receipt of charged toner forming an image to be printed, said transport path comprising:
transfer means for transferring said image to said print medium;
pressing means for pressing said print medium after receipt of said image; and
transport means running between said transfer means and said pressing means over which said print medium is transported, said transport means presenting a minimal surface area to said print medium such that any accumulated electrostatic charges are insufficient to deflect said print medium or dislodge toner from said print medium.

19. The transport path of claim 18, wherein said transport means comprise a plurality of guide ribs, wherein said ribs are substantially parallel and spaced from each other to define said transport path.

20. The transport path of claim 19, wherein said ribs are made of plastic.

21. The transport path of claim 18, further comprising enclosure means disposed with said transport means for enclosing a fire such that said transport means also serves as a fire enclosure.

22. The transport path of claim 21,
wherein said transport means comprise a plurality of guide ribs, wherein said ribs are substantially parallel and spaced from each other to define said transport path; and
wherein said enclosure means comprise a recessed plastic member spanning said plurality of ribs to cover openings between said ribs and serve as a fire enclosure.

23. The transport path of claim 22, wherein said recessed plastic member is integrally formed with said plurality of ribs.

24. The transport path of claim 18, wherein said transport path does not include an electrical discharge means.

25. A method of transporting a sheet of print medium in a printing device in which said sheet of print medium is charged to facilitate receipt of charged toner forming an image to be printed, said method comprising comprising:
sliding said sheet of print medium over a transport path which presents a minimal surface area to said print medium such that any accumulated electrostatic charges are insufficient to deflect said print medium or dislodge toner from said print medium.

26. The method of claim 25, wherein said sliding said sheet of print medium further comprises moving said print medium between a transfer roller for transferring said image to said print medium and a pressing roller for pressing said print medium after receipt of said image.

27. The method of claim 25, further comprising forming said transport path with a plurality of ribs running between said transfer roller and said pressing roller, wherein said ribs are substantially parallel and spaced from each other to define said transport path.

28. The method of claim 27, further comprising forming said ribs of plastic.

29. The method of claim 25, further comprising providing a fire enclosure with said transport path.

30. The method of claim 27, further comprising providing a fire enclosure with said transport path by disposing a recessed plastic member spanning said plurality of ribs to cover openings between said ribs.

31. The method of claim 30, further comprising integrally forming said recessed plastic member with said plurality of ribs.

32. The method of claim 25, further comprising not using an electrical discharge comb in said transport path.
